(19) United States
(12) Patent Application Publication
(10) Pub. No.: US 2006/0220268 A1
(43) Pub. Date: Oct. 5, 2006

(54) Method and mold for injection molding optical article with increased surface accuracy

(75) Inventors: Sheng-Jui Chao, Taichung (TW); Hui-Chuan Kuo, Taichung (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Asia Optical Co., Inc.

(21) Appl. No.: 11/395,760

(22) Filed: Mar. 31, 2006

(30) Foreign Application Priority Data
Apr. 1, 2005 (TW) 094110656

(51) Int. Cl. B29D 11/00

(52) U.S. Cl. 264/2.5; 425/808

(57) ABSTRACT

A method and a mold (60, 70) for injection molding an optical article (10, 50) with increased surface accuracy are disclosed. The shaping side (65, 75) of a movable mold insert (61, 71) of the injection mold is shaped corresponding to those of both optical effective area (11, 12; 51) and reference surface (13; 53) of the optical article to be molded. The gate (62, 73) of the injection mold is positioned at a location adjacent to a portion of the mold cavity (63, 74) corresponding to a large convex portion of the optical article to be molded.

### BACKGROUND OF THE INVENTION

1. Field of the Invention

The present invention relates to a method and device for forming an optical article with increased surface accuracy, and particularly relates to a method and mold for injection molding a plastic optical article with increased surface accuracy by means of mold improvement.

2. Description of Prior Art

Currently, optical lenses have been widely applied as high precision optical articles. The optical lenses can be classified into glass lenses and plastic lenses. Glass lenses are obtained via grind-and-polish technologies and thus are expensive. Plastic lenses can be mass-produced by injection molding technology, and are characterized by low costs, lightweight and great plasticity. Accordingly, plastic lenses are more commonly used in consuming products.

The injection molding process typically employs an injection mold having a mold cavity formed inside for molding the lens. Molten plastics is filled into the cavity, and then heated and pressurized for shaping. Subsequently, the mold is cooled to cool and solidify the molten plastics to form a molded plastic lens, which can then be removed from the mold to complete the molding process. U.S. Pat. Nos. 6,156,242 and 6,793,868 each disclose an injection molding method for molding plastic lens.

In the injection molding technology, the mold design is critical to the quality of the molded plastic lens. Typically, the mold insert design and the selection of the gate position directly affect the optical precision of the molded plastic lens. Once deficiencies, such as asymmetry, in surface accuracy of the molded lens occur, it is difficult to compensate these deficiencies by employing after-processing mold inserts having symmetrical shapes. The asymmetry phenomenon may be caused by several factors, such as the gate position, the mold temperature and so on, whereby the molded lens is asymmetrical along its axis after shrinkage. With the optical and mechanical design of plastic lenses becomes more and more strict and compact, and with a supporting surface on the plastic lens becomes necessary, the requirements for mold design are consequently increased. However, because of the complicated machining process of an aspheric mold insert, as well as in consideration of factors of roundness, continuous cutting and light refraction, optical manufacturers still apply greater effective diameter as the design diameter of a lens surface. Accordingly, each side of current plastic lens can be divided into two areas along the parting line during injection molding.

As illustrated in FIG. 1, below the parting line, the plastic lens 10 can be divided into a first area, i.e., an optical effective area corresponding to surfaces 11, 12, and a second supporting area corresponding to reference surface 13 for supporting the plastic lens 10 on a corresponding element. The optical effective area corresponding to surfaces 11, 12 has an effective diameter D1. Generally, the larger the second supporting area, the better the supporting precision of the reference surface 13. Similarly, above the parting line, the plastic lens 10 also can be divided into a first optical effective area corresponding to surfaces 15, 16, and a second supporting area corresponding to reference surface 17. The optical effective area corresponding to surfaces 15, 16 has an effective diameter D2.

FIG. 2 shows the structure of a conventional injection mold 20, which includes a fixed mold insert 21, an upper barrel 22, a movable mold insert 23, a lower barrel 24, and a mold cavity 25 defined between these mold inserts 21, 23 and barrels 22, 24. To ensure easy removal of the molded lens, the supporting surfaces of the lens to be molded are located on the movable side of the mold 20. As clearly shown in FIG. 2, the movable mold insert 23 has a shaping side corresponding to the first optical effective area (optical effective surfaces 11, 12) of the plastic lens 10, and the lower barrel 24 has a shaping side corresponding to the second supporting area (reference surface 13) of the plastic lens 10. The coaxial parting surface 26 of the mold 20 is located on the lower barrel 24, and the perpendicular parting surface 27 is located on the upper barrel 22. The gate 28 of the mold 20 is positioned on the right side right below the parting line. Molten plastic material is filled into the mold cavity 25 via the gate 28, so as to form a finished lens product after cooling and solidification.

As the reference surface 13 of the above plastic lens 10 is molded by the shaping side of the lower barrel 24, the positional relationship between the first and second areas of the plastic lens 10 is determined by the positional relationship between the movable mold insert 23 and the lower barrel 24. Therefore, the movement of the movable mold insert 23 directly affects the dimensional relationship between the optical effective area and the reference surface of the final molded lens 10, and even the positional relationship among the plastic lens 10, the lens barrel and other optical articles in the lens barrel.

Referring to FIG. 3, when the molded plastic lens 10 is assembled into the lens barrel 30, the position of the lens 10 is determined by the thickness “a” of a pad 31. Once the thickness “a” of the pad 31 is set, the positional relationship between the plastic lens 10 and other optical elements is also determined. As shown in FIG. 4, if a tolerance “δ” exists between the optical effective surface 12 and the reference surface 13 of the molded plastic lens 10, the size of the lens barrel 30 will be changed from original “a−k” to “a−k+δ”. This results in change of lens spacing in the lens barrel 30, and thus focusing problems of the optical system and even optical aberration problems.

Another conventional plastic lens 50, as shown in FIG. 5A, also includes first optical effective areas 51, 52 (with respective effective diameters D3, D4), and second areas corresponding to reference surfaces 53, 54. The plastic lens 50 can also be divided into a thick portion “D” and a thin portion “T”. The structure of an injection mold 40 for molding the plastic lens 50 is shown in FIG. 5B. The mold 40 includes a fixed mold insert 41, an upper barrel 42, a movable mold insert 43, a lower barrel 44, and a mold cavity 45 defined among the mold inserts 41, 43 and barrels 42, 44. The movement of the movable mold insert 43 also directly affects the lens 50 configuration, and thus the positional relationship among the lens 50, the lens barrel 30 and other optical articles disposed in the lens barrel 30.

It is clear from the above analysis that the reference surface of a molded plastic lens must be accurate in dimension, so that the relative position between the plastic lens and other optical articles in the lens barrel can be ensured. However, as the movement of the conventional mold inserts as described above directly affects the molded lens quality, such a high surface precision requirement is hard to satisfy.

Another reason for poor surface accuracy of the molded plastic lens 10, 50 attributes to the position selection of the gate 28, 46 of the conventional mold 20, 40. Detailed analysis is given below. During injection molding process, due to the shape of the mold cavity 25, 45, the pressure in the mold cavity 25, 45 is gradually increased to a high level until molten plastic material injection is finished, after which the injection pressure is changed into the holding pressure which keeps the molten plastic material filled. The holding pressure further arises to the highest point, at which time the gate is closed and molten plastic material filling is finished. However, when the molten plastic material is filled into the mold cavity 25, 45, the molten plastic material from the gate 28, 46 flows fast in a portion of the mold cavity 25, 45 adjacent to the gate 28, 46 or corresponding to the thin portion of the molded lens 10, 50, and slow in a portion of the mold cavity 25, 45 away from the gate 28, 46 or corresponding to the thick portion of the molded lens 10, 50 due to flow resistance of the emplastic molten plastic material. This filling time difference will result in uneven temperature distribution of the filled molten plastic material in different portions of the mold cavity 25, 45. The greater the plastic filling time difference, the larger the temperature distribution difference in the mold cavity 25, 45. For example, in the case of molding the plastic lens 50, since the mold cavity 45 is concaved toward the movable mold insert 43 and the gate 46 is conventionally located proximate to the top-right corner of the mold cavity 45, the concave portion of the mold cavity 45 corresponding to the thick portion D of the molded plastic lens 50 is difficult to be rapidly filled with molten plastic material due to distant from the gate 46, which results in uneven molten plastic material filling rates and temperature distribution. Similarly, in the case of molding the plastic lens 10, since a lower portion of the mold cavity 25 is concaved toward the movable mold insert 23 to a larger extent than an upper portion of the mold cavity 25 concaved toward the fixed mold insert 21 and thus is farther from the gate 28 than the upper portion, the above-mentioned uneven temperature distribution problem still exists.

During cooling process of the conventional mold 20, 40, cooling rates differ in different portions of the mold cavity 25, 45 due to temperature difference and amount difference of the filled molten plastic material. Cooling causes gradual decrease of the pressure in the mold cavity 25, 45. However, as the molten plastic material in a first portion of the mold cavity 25, 45 corresponding to the thin portion T of the molded lens 10, 50 solidifies faster than those in a second portion of the mold cavity 25, 45 corresponding to the thick portion D of the molded lens 10, 50, the plastic in the second portion of the mold cavity 25, 45 presents a relatively higher level of pressure and temperature. These pressure and temperature differences result in internal stress of the final molded lens 10, 50, and also poor surface accuracy of the final molded lens 10, 50 due to uneven shrinkage.

Accordingly, it is desired to have an injection molding method and a mold for use therein, so that a molded plastic lens with increased surface accuracy can be obtained by molding.

### SUMMARY OF THE INVENTION

An object of the present invention is to provide a method and a mold for injection molding an optical article with increased surface accuracy, which is achieved by design improvement of a mold insert.

Another object of the present invention is to provide a method and a mold for injection molding an optical article with increased surface accuracy, which is achieved by position adjustment of a mold gate.

To achieve the above objects of the present invention, a method for injection molding an optical article with increased surface accuracy, which has a large convex portion, and an optical effective area and a reference surface at one side thereof, comprises the steps of: providing a first mold insert and a second mold insert; forming a shaping side of the second mold insert into a shape conforming with those of both the optical effective area and reference surface of the optical article to be molded; assembling the mold inserts into an injection mold with a mold cavity defined therebetween, the first mold insert acting as a fixed mold insert, the second mold insert acting as a movable mold insert; defining a gate in the injection mold at a location adjacent to a portion of the mold cavity corresponding to the large convex portion of the optical article to be molded; heating the injection mold; filling molten optical material into the mold cavity through the gate for molding the optical article; pressurizing the molten optical material; cooling the injection mold to cool and solidify the molten optical material to mold the optical article in the mold cavity; and ejecting the molded optical article from the mold cavity.

The mold for use in the above method comprises a fixed mold insert, a movable mold insert, a mold cavity defined between the fixed and movable mold inserts for molding the optical article therein, and a gate positioned adjacent to a portion of the mold cavity corresponding to the large convex portion of the optical article. Molten optical material is injected into the mold cavity via the gate to form the optical article therein. The movable mold insert has a shaping side shaped conforming to those of both the optical effective area and reference surface of the optical article to be molded.

By forming the shaping side of the movable mold insert in a shape corresponding to those of both optical effective area and reference surface of the optical article to be molded, the movement of the movable mold insert relative to the mold cavity will not affect the desired dimensional relationship between the optical effective area and reference surface of the optical article, while permitting adjustment of the position of the gate relative to the mold cavity. By positioning the gate at a location adjacent to a portion of the mold cavity corresponding to the large convex portion of the optical article to be molded, increased surface accuracy of the molded optical article can be further ensured.

### BRIEF DESCRIPTION OF THE DRAWINGS

The present invention may best be understood through the following description with reference to the accompanying drawings, in which:

FIG. 1 is a schematic view of a plastic lens of a first type;

FIG. 2 is a cross-sectional view of a conventional injection mold for forming the plastic lens of FIG. 1;

FIG. 3 is a schematic view illustrating the positional relationship between the plastic lens of FIG. 1 and other optical articles in a lens barrel;

FIG. 4 is a schematic view showing dimensional tolerance on a reference surface of the plastic lens molded in the conventional injection mold of FIG. 2;

FIG. 5A is a schematic view of a plastic lens of a second type;

FIG. 5B is a cross-sectional view of another conventional injection mold for forming the plastic lens of FIG. 5A;

FIG. 6 is a cross-sectional view of an injection mold in accordance with the present invention for forming the plastic lens of FIG. 1; and

FIG. 7 is a cross-sectional view of another injection mold in accordance with the present invention for forming the plastic lens of FIG. 5A.

### DETAILED DESCRIPTION OF THE PREFERRED EMBODIMENTS AND BEST MODES FOR CARRYING OUT THE INVENTION

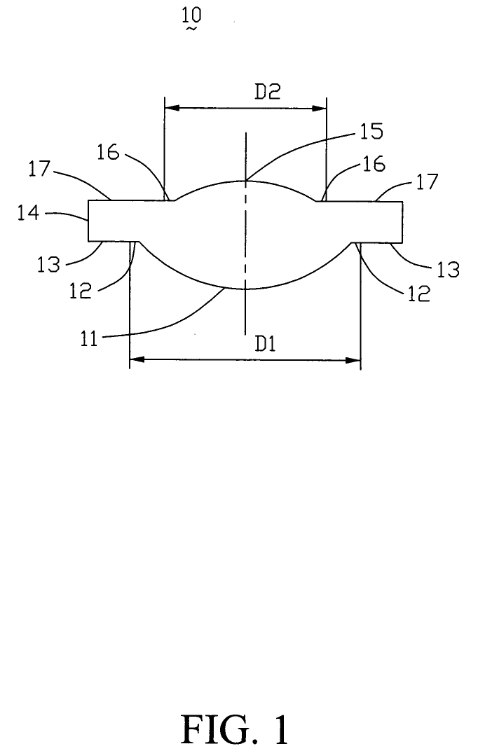

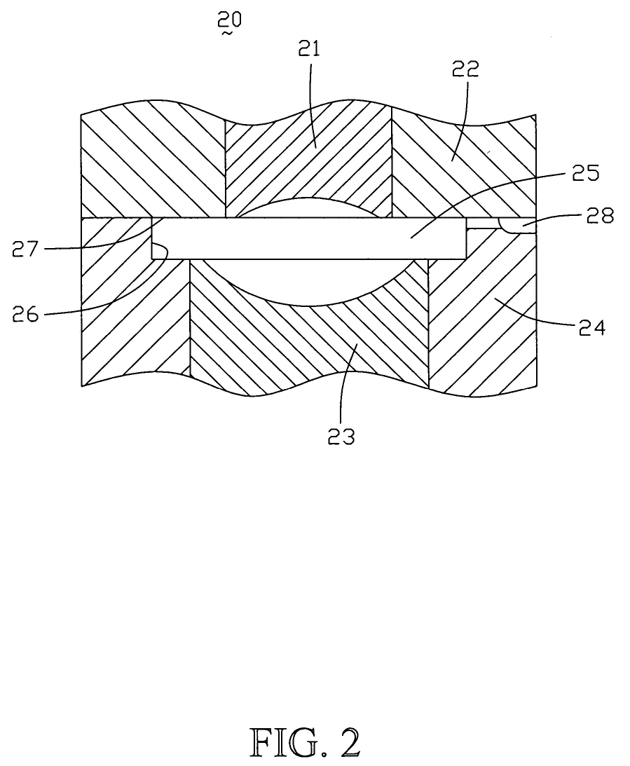

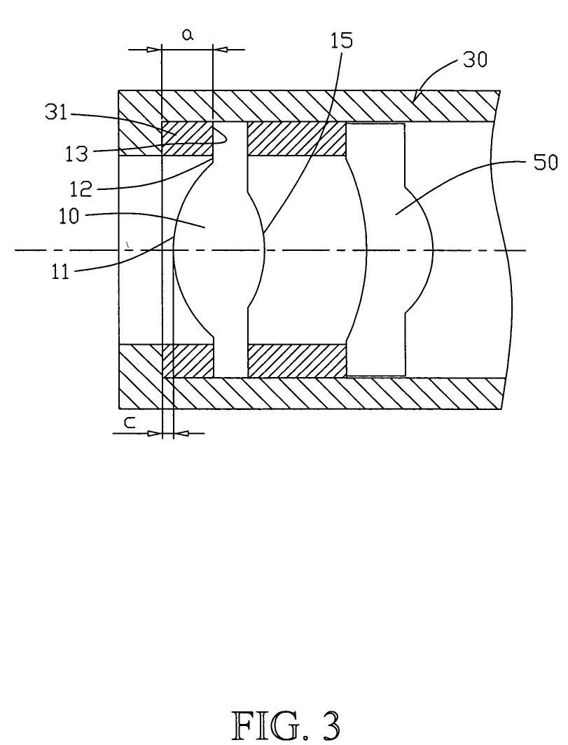

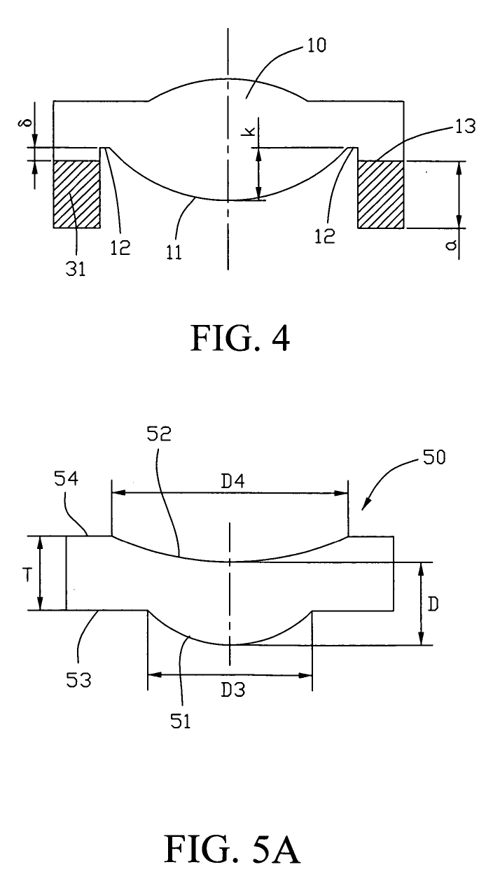

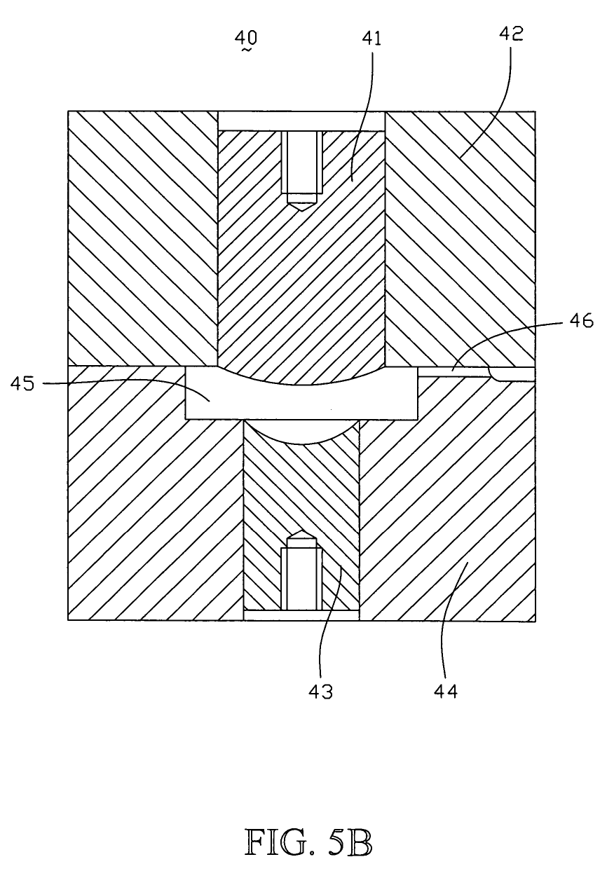

The present invention directs to a method and device for injection molding an optical article with increased surface accuracy, which is achieved by mold improvement. According to mold flow analysis, when the size of a mold gate remains unchanged but its position changes, all the shear stress, the wave-front performance and the internal stress of the molded optical article vary. For example, when the gate position is only moved 0.05 mm but the molding condition remains unchanged, the surface accuracy of the final molded optical article may get significantly increased. It is clear that the relative positional relationship between the gate and the mold inserts plays an important role on improving the surface accuracy of the molded optical article. In a preferred embodiment of the present invention, the optical article to be molded by a method in accordance with the present invention is exemplarily in the form of a plastic lens 10, 50 as illustrated in FIGS. 1 and 5A.

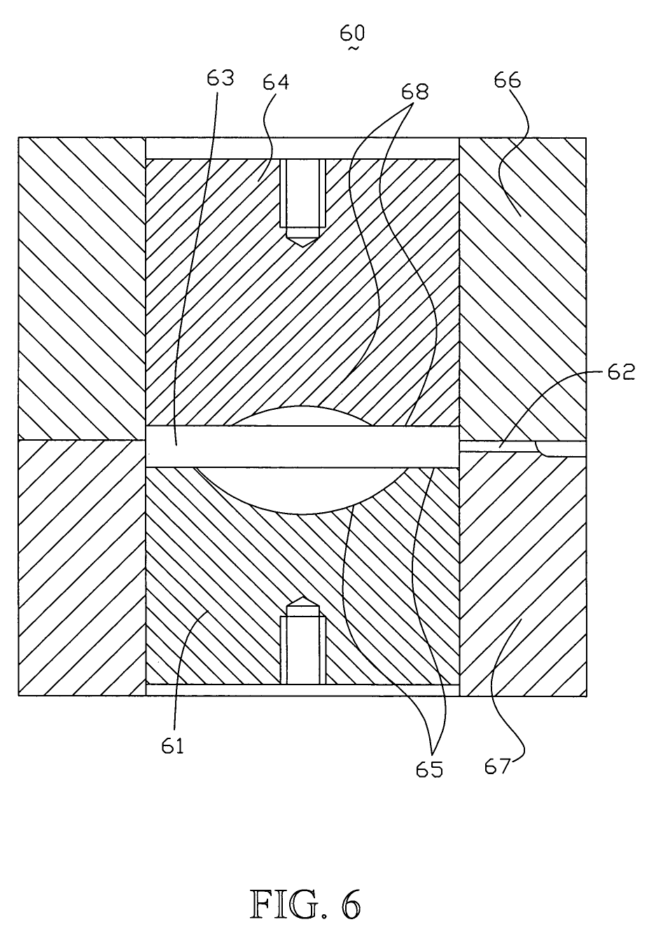

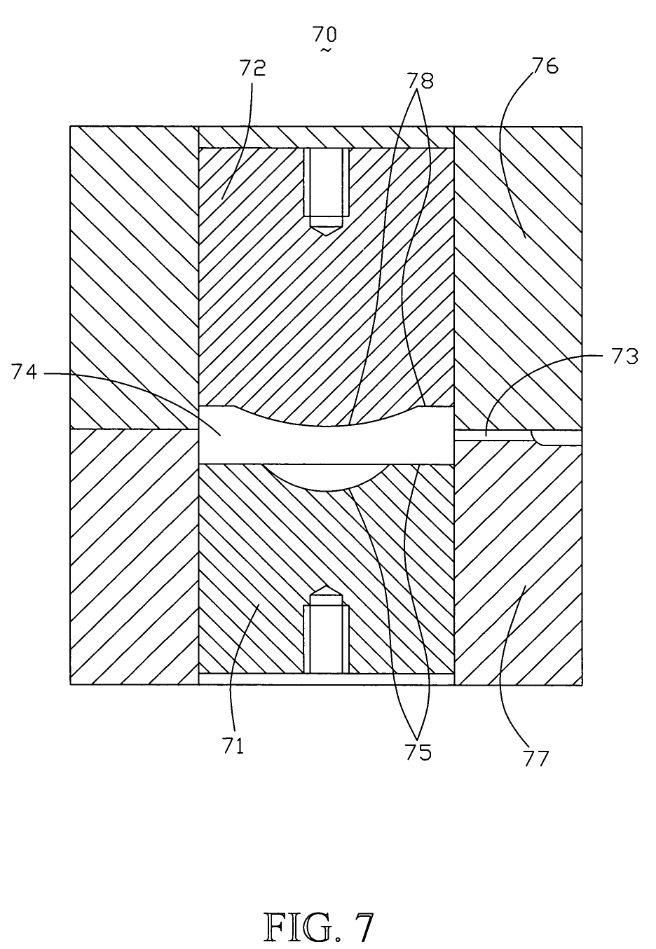

As shown in FIGS. 6 and 7, the basic structure of an injection mold 60, 70 of the present invention for forming a plastic lens 10, 50 includes a fixed mold insert 64, 72, an upper barrel 66, 76, a movable mold insert 61, 71, a lower barrel 67, 77, and a mold cavity 63, 74 defined between these mold inserts 64, 72, 61, 71 and barrels 66, 76, 67, 77. The mold cavity 63, 74, which is in a shape conforming to that of the plastic lens 10, 50 to be molded, is adapted to be filled with a molten plastic material. After the sequential mold heating, molten plastic material injection, mold closing, cooling and mold opening processes, a final plastic lens 10, 50 can be molded in the mold cavity 63, 74.

Referring to FIGS. 6 and 7 in cooperation with FIGS. 1 and 5A, the injection mold 60, 70 is different from the conventional injection mold in that its movable mold insert 61, 71 has a shaping side 65, 75 conforming with both the optical effective area 11, 12; 51 and reference surface 13; 53 at one side of the plastic lens 10, 50 to be molded, not only conforming with the optical effective area 11, 12; 51 of the plastic lens 10, 50 as the conventional design. Understandably, the fixed mold insert 64, 72 of the present invention can also be improved to include a shaping side 68, 78 conforming with both the optical effective area 15, 16; 52 and reference surface 17; 54 at the other side of the plastic lens 10, 50 to be molded. The shaping side 65, 75 of the present movable mold insert 61, 71 is integrally formed by lathing, whereby the surface accuracy of the final molded plastic lens 10, 50 can be significantly improved since the heat transfer efficiency of the mold inserts is the same. In addition, since the shaping side 65, 75 of the present movable mold insert 61, 71 conforms with both the optical effective area 11, 12; 51 and reference surface 13; 53 of the plastic lens 10, 50, the movement of the movable mold insert 61, 71 will no longer affect the structural relationship between the optical effective area 11, 12; 51 and reference surface 13; 53 of the final molded plastic lens 10, 50. Meanwhile, the position of the gate 62, 73 relative to the mold cavity 63, 74 can be correspondingly changed via the movement of the movable mold insert 61, 71, which further prevents the asymmetrical phenomenon from occurring to the final molded lens 10, 50.

The plastic lens 10, 50 to be molded includes a large convex portion corresponding to the optical effective surface 11, 51. Correspondingly, a large concave is formed at the bottom of the mold cavity 63, 74 of the movable mold insert 61, 71. To ensure increased surface accuracy of the final molded lens 10, 50, the gate 62, 73 of the present mold 60, 70 is located more adjacent to the large concave of the mold cavity 63, 74 than the conventional design. The distance between the gate 62, 73 and the concave bottom of the mold cavity 63, 74 thus can be decreased. According to mold flow analysis, by adjusting the gate 62, 73 position, temperature distribution in various portions of the mold cavity 63, 74 tends to be uniform, whereby asymmetrical phenomenon and thus the surface accuracy of the molded plastic lens can be significantly improved.

As analyzed in the previous Description of Prior Art section, during molding process, temperature difference exists in the plastic material filled in the mold cavity 63, 74 due to volume difference, which will result in poor surface accuracy of the final molded plastic lens. To overcome this problem, the present invention allows position adjustment of the gate 62, 73 relative to the mold cavity 63, 74 via the movement of the movable mold insert 61, 71. According to mold flow analysis, even minor movement of the gate 62, 73 can cause almost 10° C. temperature difference of the plastic material compared with the conventional design. This allows even cooling of the plastic material and thus increases the surface accuracy of the final molded plastic lens 10, 50. The thus molded plastic lens 10, 50 will not affect the positional relationship with the lens barrel and other optical articles in the lens barrel, thereby ensuring precision optical performance of the entire optical system.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for injection molding an optical article with increased surface accuracy, the optical article to be molded having an optical effective area and a reference surface at one side thereof, the method comprising the following steps:
providing a first mold insert, a first barrel for surrounding the first mold insert, a second mold insert, and a second barrel for surrounding the second mold insert;
forming a shaping side of the second mold insert into a shape conforming to those of both the optical effective area and reference surface of the optical article to be molded;
assembling the mold inserts and barrels into an injection mold with a mold cavity defined therebetween, the first mold insert acting as a fixed mold insert, the second mold insert acting as a movable mold insert;
defining a gate in the injection mold;
heating the injection mold;
filling molten optical material into the mold cavity through the gate for molding the optical article;
pressurizing the molten optical material;
cooling the injection mold to cool and solidify the molten optical material to mold the optical article in the mold cavity; and
ejecting the molded optical article from the mold cavity.

2. The method as claimed in claim 1, wherein the shape of the mold cavity conforms to that of the optical article to be molded.

3. The method as claimed in claim 2, wherein the optical article to be molded is a plastic lens having thick and thin portions.

4. The method as claimed in claim 3, wherein the gate is located adjacent to a portion of the mold cavity corresponding to the thick portion of the plastic lens to be molded.

5. The method as claimed in claim 2, wherein the optical article is a plastic lens with a large convex portion.

6. The method as claimed in claim 5, wherein the gate is located adjacent to a portion of the mold cavity corresponding to the large convex portion of the plastic lens to be molded.

7. The method as claimed in claim 1, wherein the shaping side of the second mold insert is integrally formed by lathing.

8. The method as claimed in claim 7, before the assembling step, further comprising a step of forming a shaping side of the first mold insert into a shape conforming to those of both optical effective area and reference surface at the other side of the optical article to be molded.

9. An injection mold for molding an optical article with increased surface accuracy, the optical article to be molded having an optical effective area and a reference surface at one side thereof, the reference surface being adapted for supporting the molded optical article on a corresponding element, the injection mold including a fixed mold insert, a movable mold insert, a mold cavity defined between the fixed and movable mold inserts, and a gate; the mold cavity receiving molten optical material injected therein via the gate to form the optical article; the movable mold insert having a shaping side shaped conforming with those of both the optical effective area and reference surface of the optical article to be molded; the movable mold insert being movable relative to the mold cavity without affecting the desired dimensional relationship between the optical effective area and reference surface of the optical article.

10. The injection mold as claimed in claim 9, wherein the shape of the mold cavity conforms to that of the optical article to be molded.

11. The injection mold as claimed in claim 10, wherein t the gate is located adjacent to a portion of the mold cavity corresponding to a thick portion of the optical article to be molded.

12. The injection mold as claimed in claim 10, wherein the gate is located adjacent to a portion of the mold cavity corresponding to a large convex portion of the optical article to be molded.

13. The injection mold as claimed in claim 9, wherein the shaping side of the movable mold insert is integrally formed by lathing.

14. The injection mold as claimed in claim 13, wherein the fixed mold insert has a shaping side shaped conforming to those of both optical effective area and reference surface at the other side of the optical article to be molded.

15. An injection mold for molding an optical article with increased surface accuracy, the optical article to be molded having a large convex portion, the injection mold including a fixed mold insert having a first shaping side shaped conforming with one side of the optical article to be molded, a movable mold insert having a second shaping side shaped conforming with the other side of the optical article to be molded, and a gate; the fixed and movable mold inserts being arranged with the first and second shaping sides thereof facing each other to define a mold cavity between; the mold cavity receiving molten optical material injected therein via the gate to form the optical article therein; the gate being located adjacent to a portion of the mold cavity corresponding to the convex portion of the optical article to be molded.

16. The injection mold as claimed in claim 15, wherein said one side of the optical article to be molded includes an optical effective area and a reference surface for supporting the optical article on a corresponding element.

17. The injection mold as claimed in claim 15, wherein said the other side of the optical article to be molded includes an optical effective area and a reference surface for supporting the optical article on a corresponding element.
